(19) United States
(12) Patent Application Publication
(10) Pub. No.: US 2013/0075985 A1
(43) Pub. Date: Mar. 28, 2013

(54) CONVERSION DEVICE OF POWER TOOL

(71) Applicant: Long Chang, Brooklyn, NY (US)

(72) Inventor: Long Chang, Brooklyn, NY (US)

(21) Appl. No.: 13/240,432

(22) Filed: Sep. 22, 2011

(51) Int. Cl. B25F 3/00

(52) U.S. Cl. 279/144

(57) ABSTRACT

A conversion device of power tool includes a cutting unit, a housing, an elastic unit, a transmission unit and a connection unit. The cutting unit is inserted in an insertion hole of the connection unit and connected therewith. When the transmission unit is rotated, the elastic unit is kept compressed and released repeatedly that motion makes the cutting unit be pushed and reciprocally moved. The conversion device is applicable to a power tool to easily convert the power tool into a reciprocal linear motion power tools, such as power saw for convenient use.

### BACKGROUND OF THE INVENTION

1. Field of the Invention

The present invention relates generally to a conversion device of power tool, and more particularly to a conversion device, which is applicable to a rotary motion power tool to easily convert such rotary motion power tool into a reciprocal linear motion power tool such as power saw, or power chisel, etc. for convenient use.

2. Description of the Related Art

A conventional power tool such as a power saw or power drill includes a drive unit and a transmission unit integrally connected with the drive unit. Such power tool only has one single function such as sawing or drilling. In case a power saw and a power drill are both needed, it is necessary for a user to purchase both. This is not economic. Moreover, it is inconvenient to use both the power saw and power drill.

Furthermore, a common tool box has limited space and is hard to accommodate too many tools. To solve this problem, a universal adapter has been developed. The adapter can be installed onto the chuck of a power drill and a saw blade can be connected with the adapter to convert the power drill into a power saw. This is quite convenient and economic. It is therefore tried by the applicant to provide a conversion device of power tool to solve the problems of cost waste and inconvenience in use of the power tool that exist in the conventional device.

### SUMMARY OF THE INVENTION

A primary object of the present invention is to provide a conversion device of rotary motion power tool, which is applicable to such a power tool to easily convert the rotary motion power tool into a reciprocal linear motion power tool such as power saw, etc.

A further object of the present invention is to provide the above conversion device of power tool, which can be conveniently used.

To achieve the above and other objects, the conversion device of power tool of the present invention includes a cutting unit, a housing, an elastic unit, a transmission unit and a connection unit. The housing includes a base and a cap member connected with the base. The base has a first side and a second side. The second side has a receiving space. The base is formed with a perforation in communication with the receiving space. The cap member is formed with an opening.

The elastic unit is encapsulated in the receiving space and has a through hole. The transmission unit is disposed between the elastic unit and the cap member. One end of the transmission unit extends through the through hole and the perforation. The other end of the transmission unit extends through the opening of the cap member out of the cap member. The connection unit has an insertion hole and a mating member. The insertion hole is formed on one side of the connection unit for connecting with one end of the cutting unit. The mating member extends from the other side of the connection unit to connect with one end of the transmission unit. The conversion device of the present invention is applicable to a power tool, whereby the power tool can be easily converted into a reciprocal linear motion power tool such as power saw for convenient use.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a perspective assembled view of a first embodiment of the present invention;

FIG. 2 is perspective exploded view of the first embodiment of the present invention;

FIG. 3 is a sectional assembled view of the first embodiment of the present invention;

FIG. 4 is a perspective view of a second embodiment of the present invention, showing that the present invention is applied to a power tool;

FIG. 5 is a perspective assembled view of a third embodiment of the present invention;

FIG. 6 is perspective exploded view of the third embodiment of the present invention;

FIG. 7 is a sectional assembled view of the third embodiment of the present invention;

FIG. 8 is a perspective view of a fourth embodiment of the present invention, showing that the present invention is applied to a power tool;

FIG. 9 is a perspective assembled view of a fifth embodiment of the present invention;

FIG. 10 is perspective exploded view of the fifth embodiment of the present invention;

FIG. 11 is a sectional assembled view of the fifth embodiment of the present invention;

FIG. 12A is a perspective view of the fitting member of the fifth embodiment of the present invention;

FIG. 12B is another perspective view of the fitting member of the fifth embodiment of the present invention; and

FIG. 13 is a perspective view showing that the fifth embodiment of the present invention is applied to a power tool.

### DETAILED DESCRIPTION OF THE PREFERRED EMBODIMENTS

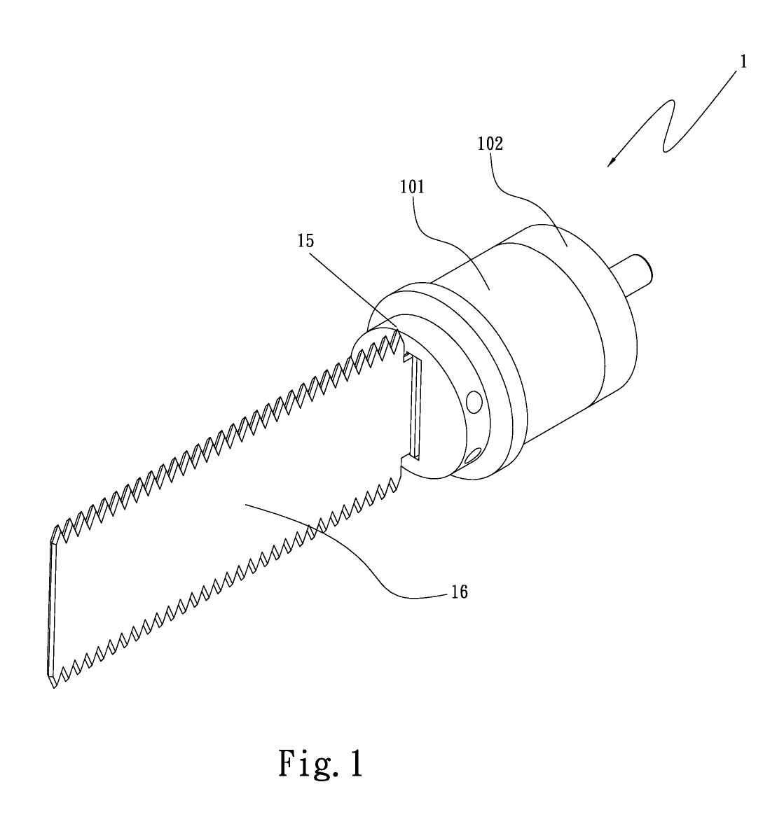

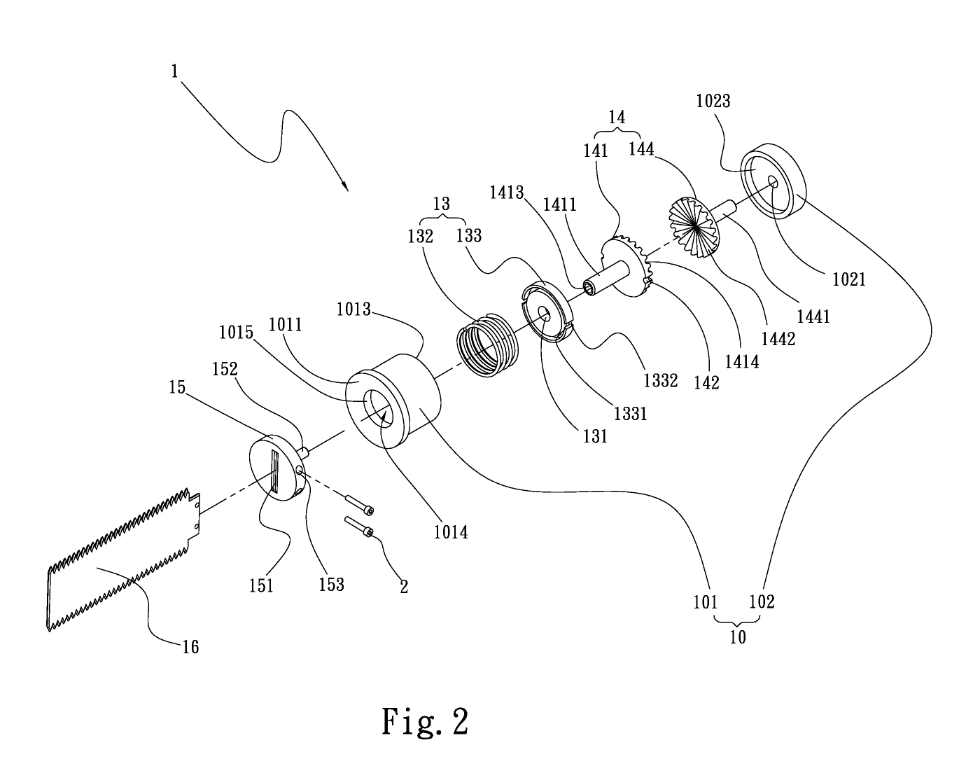

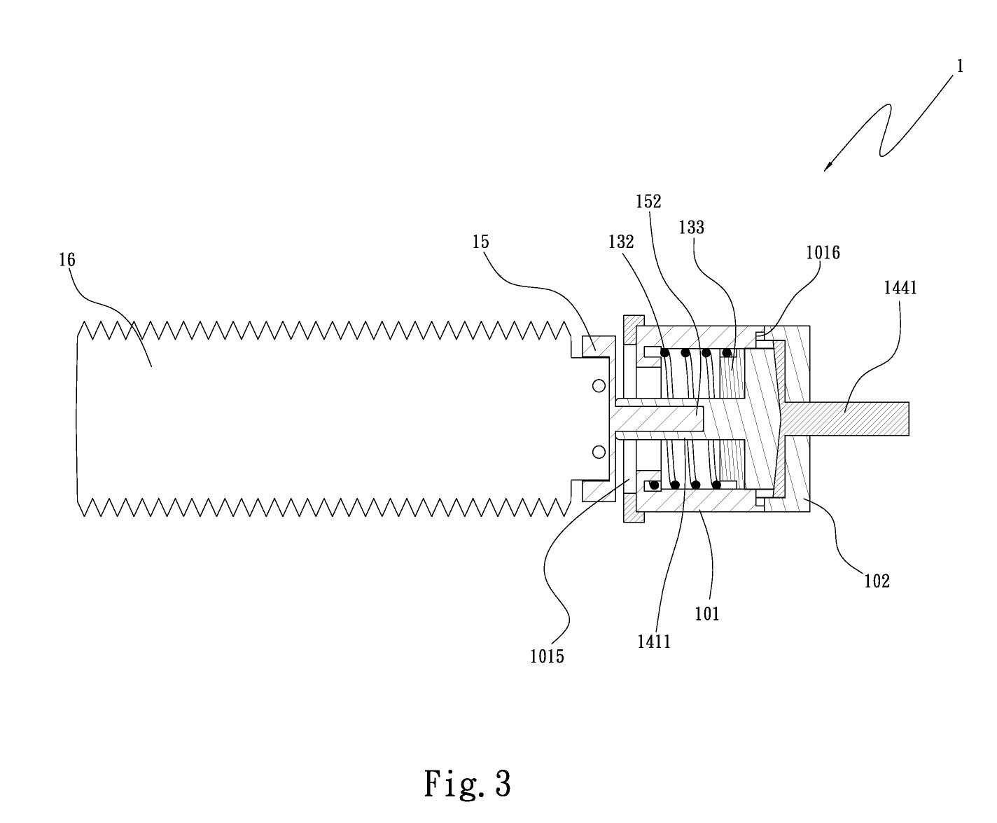

Please refer to FIGS. 1, 2 and 3. FIG. 1 is a perspective assembled view of a first embodiment of the present invention. FIG. 2 is perspective exploded view of the first embodiment of the present invention. FIG. 3 is a sectional assembled view of the first embodiment of the present invention. According to the first embodiment, the conversion device 1 of power tool of the present invention includes a cutting unit 16, a housing 10, an elastic unit 13, a transmission unit 14 and a connection unit 15. The cutting unit 16 is selected from a group consisting of a saw blade, a chisel, a hammer, a blade and a file. The cutting unit 16 is linearly back and forth movable for cutting a work piece. In practice, different sizes and kinds of saw blades can be freely replaced with each other according to the sizes of the work pieces. The housing 10 includes a base 101 and a cap member 102 connected with the base 101. The base 101 has a first side 1011, a second side 1013 and at least one raised section 1016.

The second side 1013 has a receiving space 1014 for encapsulating the elastic unit 13 therein. The cap member 102 is capped on the second side 1013 to close the receiving space 1014. The base 101 is formed with a perforation 1015 in communication with the receiving space 1014. The raised section 1016 protrudes from inner circumference of the base 101 toward the center of the receiving space 1014.

The cap member 102 is formed with a recessed section 1023 and an opening 1021. One end of the transmission unit 14 extends through the opening 1021 out of the cap member 102. The recessed section 1023 is formed on one side of the cap member 102, which side faces the transmission unit 14. The recessed section 1023 and the receiving space 1014 together accommodate the transmission unit 14 and the elastic unit 13.

Please further refer to FIG. 2 as well as FIG. 3. The elastic unit 13 has an elastic member 132 and a retainer member 133. A through hole 131 is formed at a center of the retainer member 133. The retainer member 133 has a depression 1331 and multiple first locating notches 1332. The depression 1331 is formed on one side of the retainer member 133, which side faces the elastic member 132 around the through hole 131. One end of the elastic member 132 is inlaid in the depression 1331. The other end of the elastic member 132 abuts against a closed side of the receiving space 1014. When the elastic unit 13 is pushed (or moved) forward by the transmission unit 14, the elastic member 132 is compressed to apply a reaction force to the transmission unit 14 for rebounding the transmission unit 14.

The first locating notches 1332 are formed on a circumference of the retainer member 133 corresponding to the raised section 1016. The raised section 1016 is inserted in the first locating notches 1332. The transmission unit 14 is positioned between the elastic unit 13 and the cap member 102. One end of the transmission unit 14 extends through the through hole 131 and the perforation 1015, while the other end of the transmission unit 14 extends through the opening 1021 out of the cap member 102.

The transmission unit 14 has a first transmission member 141 and a second transmission member 144 opposite to the first transmission member 141. Multiple second locating notches 142 are formed on a circumference of the first transmission member 141 in alignment with the first locating notches 1332. The raised section 1016 is also inserted in the second locating notches 142.

Please further refer to FIG. 2. The first transmission member 141 has a first extension section 1411 and a first engagement section 1414 opposite to the first extension section 1411. The first extension section 1411 is formed on and extends from one side of the first transmission member 141. The first extension section 1411 is formed with a receiving socket 1413 for receiving one end of a mating member 152 to connect the first extension section 1411 with the mating member 152. The first engagement section 1414 is formed on the other side of the first transmission member 141 opposite to the second transmission member 144. The first engagement section 1414 has the form of a wave shaped plate.

The second transmission member 144 has a second extension section 1441 and a second engagement section 1442 for engaging with the first engagement section 1414. The second extension section 1441 is formed on and extends from one side of the second transmission member 144. The second engagement section 1442 is formed on the other side of the second transmission member 144. The second engagement section 1442 also has the form of a wave shaped plate.

When the second transmission member 144 is rotated, the second engagement section 1442 rotationally pushes and drives the first engagement section 1414 to move the first transmission member 141 forward. Accordingly, the cutting unit 16 affixed to the connection unit 15 is moved forward. In the meantime, the elastic member 132 is compressed to apply a reaction force to the first transmission member 141 for moving the first transmission member 141 toward the second transmission member 144, (that is, for moving the first transmission member 141 backward). At this time, the cutting unit 16 affixed to the connection unit 15 is moved backward along with the first transmission member 141 until the first engagement section 1414 of the first transmission member 141 is engaged with the second engagement section 1442 again. Then the second engagement section 1442 keeps rotating to push and move the first engagement section 1414. Accordingly, the first transmission member 141 is reciprocally moved back and forth to drive the cutting unit 16 so as to achieve its cutting effect.

The connection unit 15 has an insertion hole 151, at least one passage 153 and a mating member 152. The insertion hole 151 is formed on one side of the connection unit 15 for connecting with one end of the cutting unit 16. The mating member 152 extends from the other side of the connection unit 15 to connect with one end of the transmission unit 14. That is, the mating member 152 is fixedly plugged into the receiving socket 1413 of the first extension section 1411.

The passage 153 extends from a circumference of the connection unit 15 through the body of connection unit 15 to the insertion hole 151. At least one fastening member 2 is inserted into the passage 153 to lock the end of the cutting unit 16.

By means of the conversion device 1 of the present invention, the saw blade can be conveniently reciprocally moved to achieve a cutting effect.

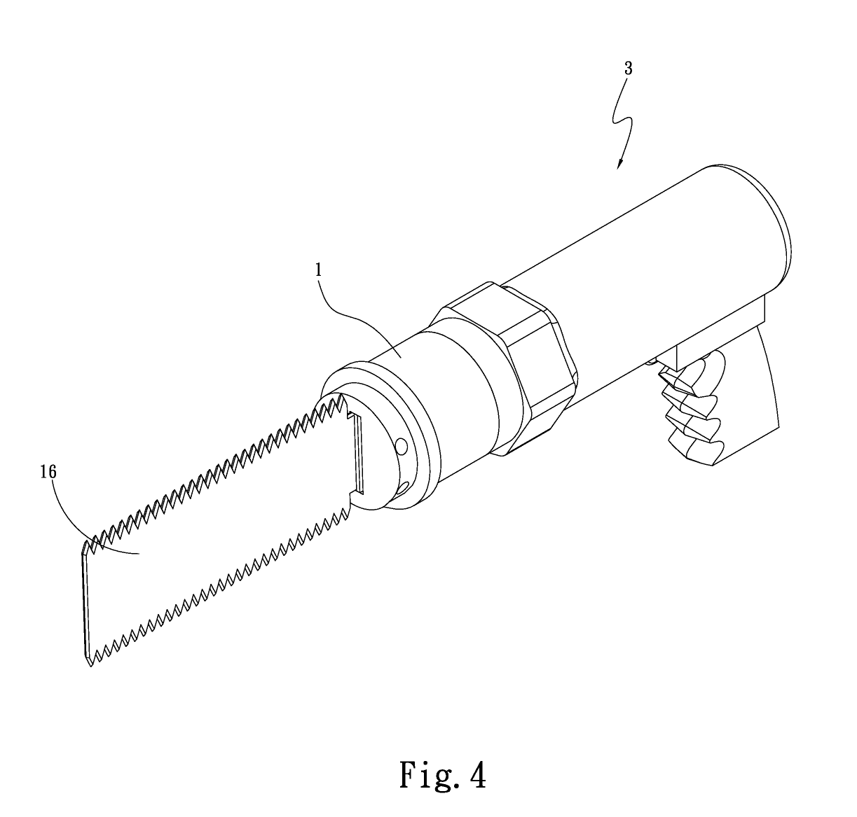

Please refer to FIG. 4. FIG. 4 is a perspective view of a second embodiment of the present invention, showing that the present invention is applied to a power tool. Also referring to FIGS. 2 and 3, the first embodiment of the conversion device 1 is applied to a power tool 3 such as a power drill. To speak more specifically, the second extension section 1441 of the second transmission member 144 is an attachable unit which is connected to a corresponding power tool 3. When the power tool 3 operates, the second extension section 1441 is rotated with the rotation of the power tool 3.

When a user desires to replace the bit (such as the drill bit) of the power tool 3, the user only needs to detach the drill bit from the power tool 3 and then install the second extension section 1441 of the conversion device 1 onto the power tool 3. Accordingly, by means of the conversion device 1 of the present invention, it is unnecessary to purchase an additional power saw or other power tools. Therefore, it costs less because the power drill can be converted into a power saw for convenient use.

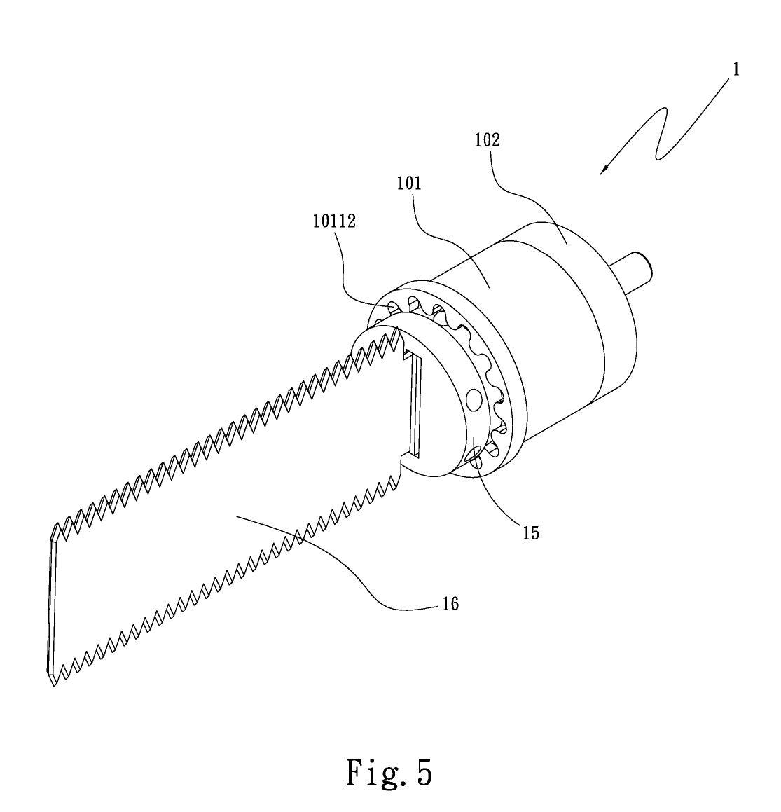

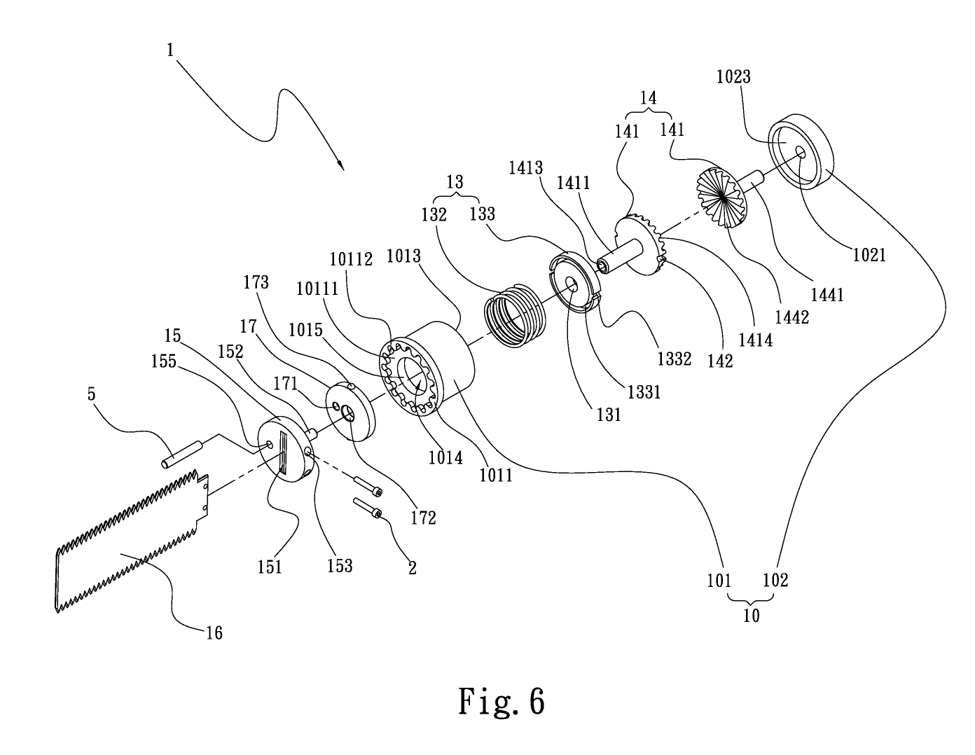

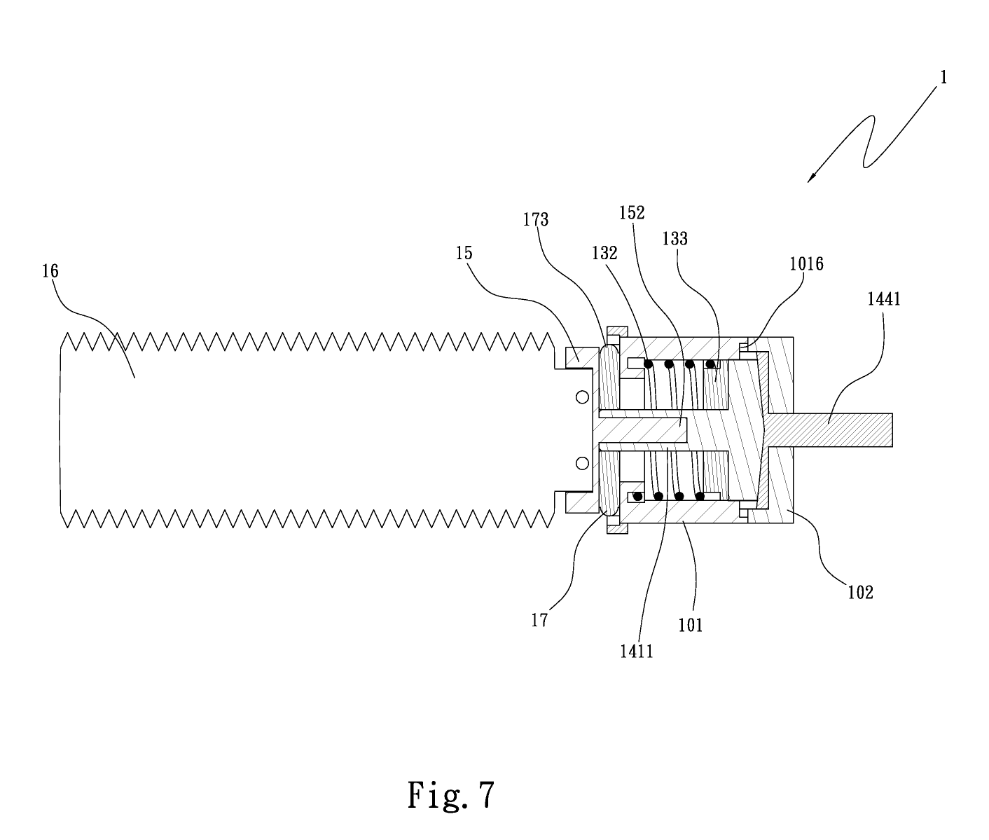

Please now refer to FIGS. 5, 6 and 7. FIG. 5 is a perspective assembled view of a third embodiment of the present invention. FIG. 6 is perspective exploded view of the third embodiment of the present invention. FIG. 7 is a sectional assembled view of the third embodiment of the present invention. The third embodiment is substantially identical to the first embodiment in structure and connection relationship and thus will not be repeatedly described hereinafter. The only difference between the third embodiment and the first embodiment is that an adjustable rotary member 17 is further placed in between the connection unit 15 and the base 101. The adjustable rotary member 17 has a first restriction hole 171 passing through the adjustable rotary member 17, a through hole 172 aligned with the insertion hole 151 and an extensible/retractable key section 173. The through hole 172 is formed at a center of the adjustable rotary member 17 in adjacency to the first restriction hole 171.

The mating member 152 sequentially extends through the through hole 172 and plugs into the receiving socket 1413 of the first extension section 1411.

Accordingly, the connection unit 15 is rotatable with the rotation of the adjustable rotary member 17. The key section 173 is positioned on a circumference of the adjustable rotary member 17.

The base 101 is further formed with a sink 10111 and multiple tooth-shaped dents 10112. The sink 10111 is formed on a first side 1011 of the base 101 opposite to the receiving space 1014. The sink 10111 together with the perforation 1015 and the receiving space 1014 form a space for mounting the adjustable rotary member 17. The tooth-shaped dents 10112 are formed along circumferential wall of the sink 10111 for engaging with the corresponding key section 173.

The connection unit 15 is further formed with a second restriction hole 155 passing through the connection unit 15 between the insertion hole 151 and the circumference of the connection unit 15. The second restriction hole 155 communicates with the first restriction hole 171. An insertion pin 5 is inserted through the second and first restriction holes 155, 171 to restrict the adjustable rotary member 17 from rotating. When a user desires to adjust the working direction (or working angle) of the cutting unit 16, the user only needs to extract the insertion pin 5 out of the first and second restriction holes 171, 155 and then rotate the adjustable rotary member 17 (clockwise or counterclockwise).

When the adjustable rotary member 17 is rotated, the key section 173 is retracted because of being pressed by the wall of the tooth-shaped dent 10112. After the adjustable rotary member 17 is adjusted to the desired position, the key section 173 bounds out of the adjustable rotary member 17 to engage in the corresponding tooth-shaped dent 10112. Then the user again sequentially inserts the insertion pin 5 through the second restriction hole 155 and the first restriction hole 171 to restrict the connection unit 15 from rotating shift. Accordingly, the working angle can be easily adjusted to facilitate use.

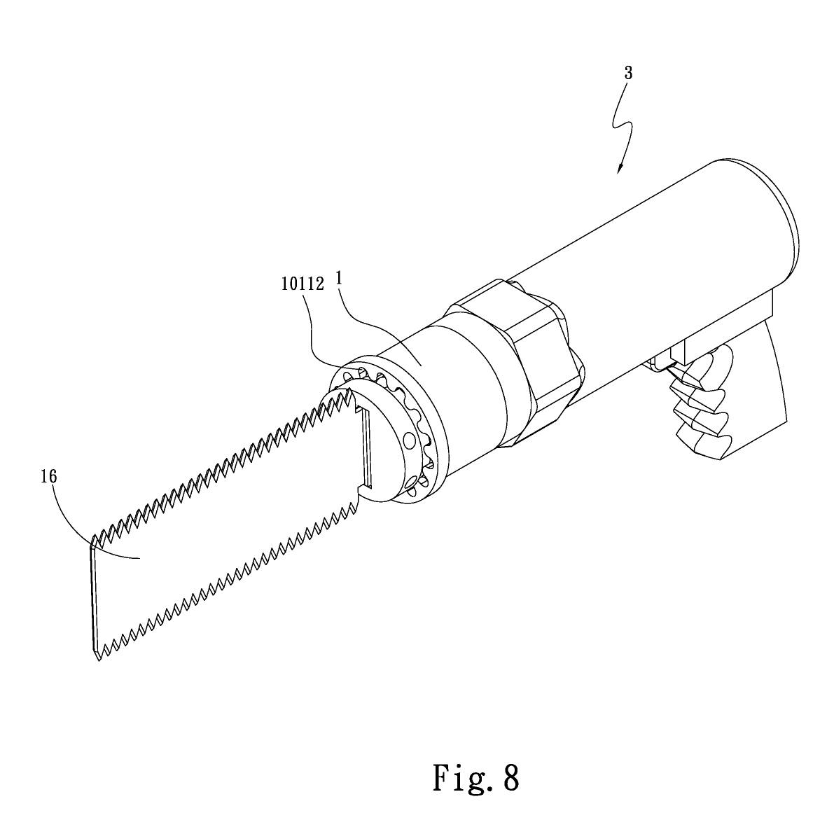

Please refer to FIG. 8. FIG. 8 is a perspective view of a fourth embodiment of the present invention, showing that the present invention is applied to a power tool. The third embodiment of the conversion device 1 is applied to a power tool 3 such as a power drill.

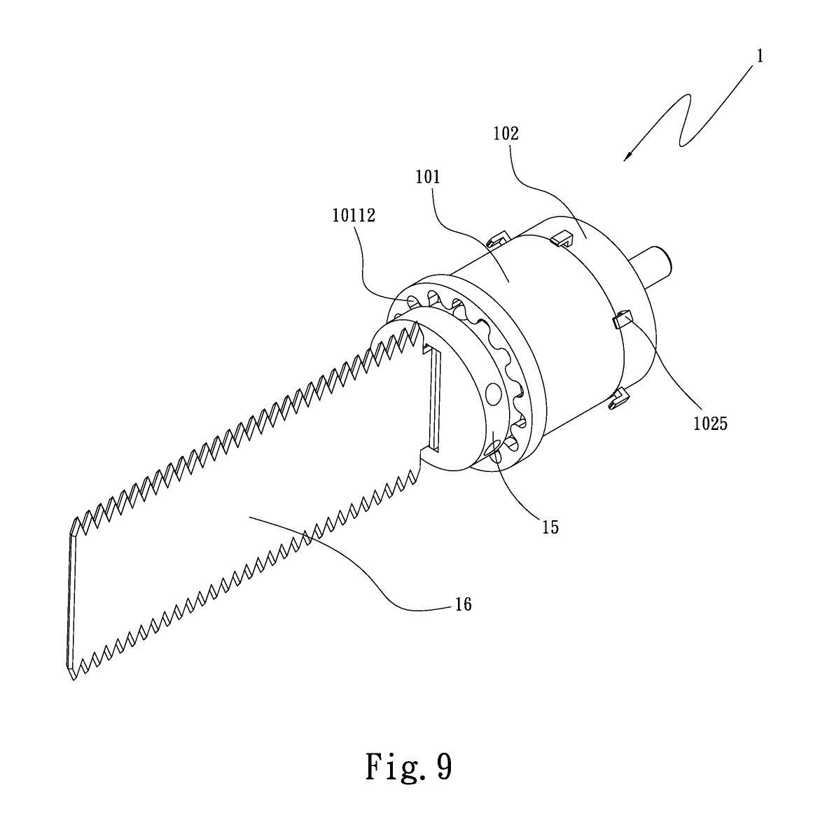

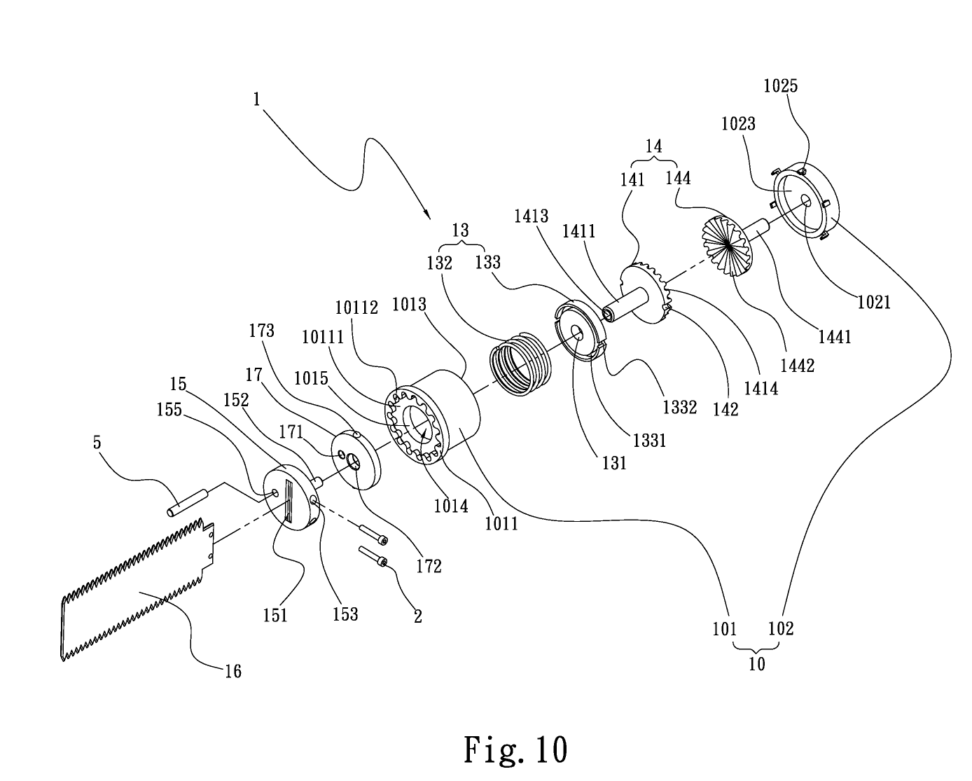

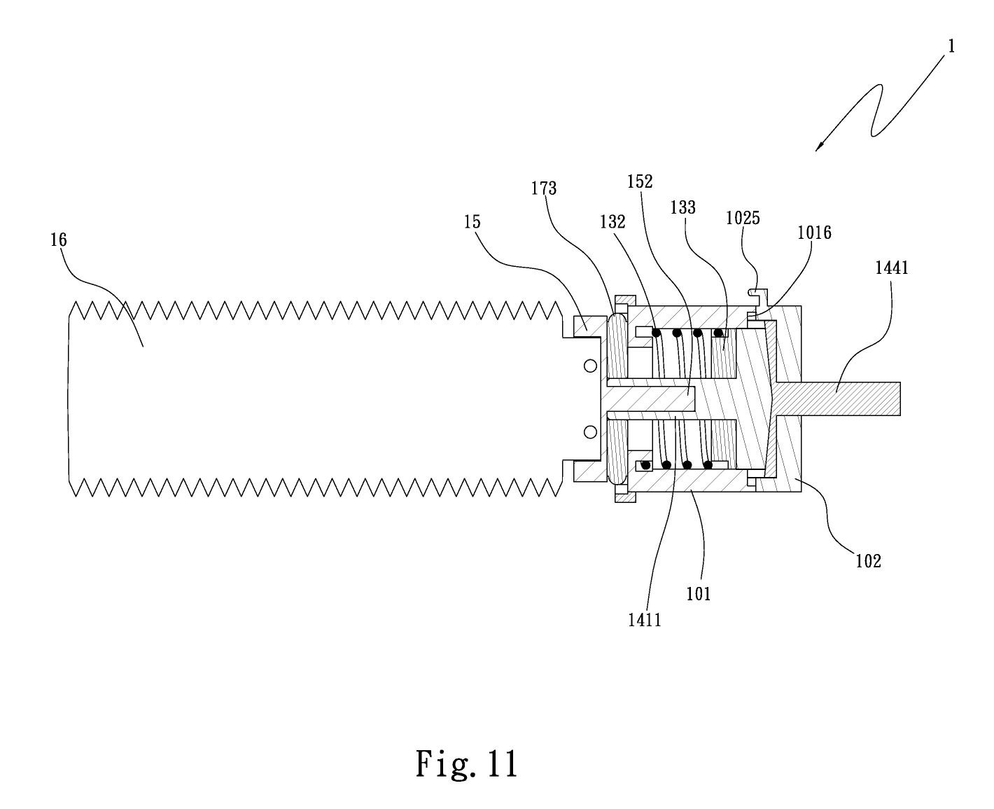

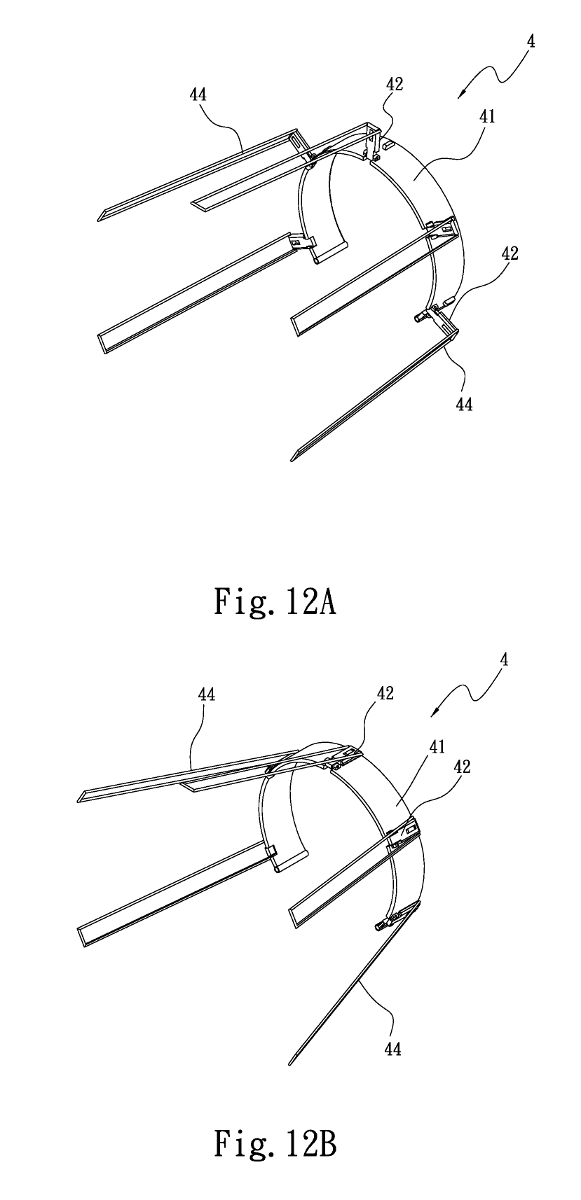

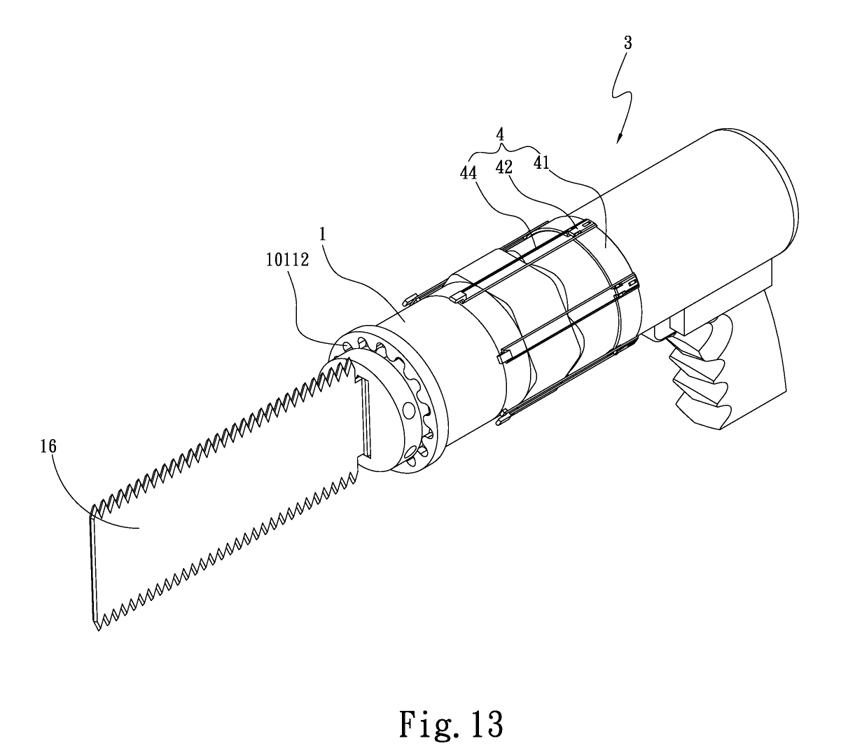

Please now refer to FIGS. 9, 10, 11, 12A, 12B and 13. FIG. 9 is a perspective assembled view of a fifth embodiment of the present invention. FIG. 10 is perspective exploded view of the fifth embodiment of the present invention. FIG. 11 is a sectional assembled view of the fifth embodiment of the present invention. FIG. 12A is a perspective view of the fitting member of the fifth embodiment of the present invention. FIG. 12B is another perspective view of the fitting member of the fifth embodiment of the present invention. FIG. 13 is a perspective view showing that the fifth embodiment of the present invention is applied to a power tool. The fifth embodiment is substantially identical to the third embodiment in structure and connection relationship and thus will not be repeatedly described hereinafter. The fifth embodiment is only different from the third embodiment in that the cap member 102 has multiple hook sections 1025 annularly arranged along the circumference of the cap member 102. The second extension section 1441 of the second transmission member 144 is attached and connected to a corresponding power tool 3 (such as a power drill). When the power tool 3 operates, the second extension section 1441 is rotated with the rotation of the power tool 3. The power tool 3 is fitted with a corresponding fitting member 4.

Please now refer to FIGS. 10, 12A, 12B and 13. The fitting member 4 has a ring body 41, multiple movable sections 42 and multiple latch sections 44. The movable sections 42 are arranged at one end of the ring body 41 at intervals. The free ends of the movable sections 42 are movably connected with the corresponding latch sections 44. The latch sections 44 are fixedly fitted on the corresponding hook sections 1025 so as to prevent the housing 10 of the conversion device 1 from rotating along with the power tool 3.

In conclusion, the cutting unit 16, the housing 10, the elastic unit 13, the transmission unit 14 and the connection unit 15 are integrated to form the conversion device 1 of the present invention. The conversion device 1 of the present invention is applicable to a power tool 3, whereby the power tool can be easily converted into a reciprocal linear motion power tool, such as power saw, for convenient use. It is unnecessary to spend extra money to purchase a an additional power saw to perform such task.

According to the above, in comparison with the conventional device, the present invention has the following advantages:
1. By means of the conversion device of the present invention, a rotary motion power drill can be easily converted into a reciprocal linear motion power tools, such as power saw, power chisel, etc.
2. It is convenient to use the conversion device of the present invention.
3. It is unnecessary to purchase an additional power saw so that the cost is saved.

The above embodiments are only used to illustrate the present invention, not intended to limit the scope thereof. It is understood that many changes and modifications of the above embodiments can be made without departing from the spirit of the present invention. The scope of the present invention is not only limited by the appended claims.

What is claimed is:

1. A conversion device of power tool, comprising:
a cutting unit;
a housing including a base and a cap member connected with the base, the base having a first side and a second side, the second side having a receiving space, the base being formed with a perforation in communication with the receiving space, the cap member being formed with an opening;
an elastic unit encapsulated in the receiving space and having a through hole;
a transmission unit disposed in between the elastic unit and the cap member, one end of the transmission unit extending through the through hole and the perforation, the other end of the transmission unit extending through the opening of the cap member out of the cap member; and
a connection unit having an insertion hole and a mating member, the insertion hole being formed on one side of the connection unit for connecting with one end of the cutting unit, the mating member extending from the other side of the connection unit to connect with one end of the transmission unit.

2. The conversion device of power tool as claimed in claim 1, wherein the base further has at least one raised section protruding from inner circumference of the base toward a center of the receiving space.

3. The conversion device of power tool as claimed in claim 2, wherein the elastic unit has an elastic member and a retainer member, the retainer member having a depression and multiple first locating notches, the depression being formed on one side of the retainer member, which side faces the elastic member, one end of the elastic member being inlaid in the depression, the first locating notches being formed on a circumference of the retainer member corresponding to the raised section, whereby the raised section is inserted in the first locating notches, the through hole being formed at a center of the retainer member.

4. The conversion device of power tool as claimed in claim 1, wherein the transmission unit has a first transmission member and a second transmission member opposite to the first transmission member, multiple second locating notches being formed on a circumference of the first transmission member in alignment with the first locating notches, the raised section being also inserted inlaid in the second locating notches, the first transmission member having a first extension section and a first engagement section, the first extension section being formed on one side of the first transmission member, the first engagement section being formed on and extending from the other side of the first transmission member, the second transmission member having a second extension section and a second engagement section for engaging with the first engagement section, the second extension section being formed on and extending from one side of the second transmission member, the second engagement section being formed on the other side of the second transmission member.

5. The conversion device of power tool as claimed in claim 4, wherein the first extension section is formed with a receiving socket for receiving one end of the mating member.

6. The conversion device of power tool as claimed in claim 1, wherein the connection unit further has at least one passage, the passage extending from a circumference of the connection unit through the connection unit in with the insertion hole, at least one fastening member being inserted into the passage to lock the end of the cutting unit.

7. The conversion device of power tool as claimed in claim 4, further comprising of an adjustable rotary member disposed between the connection unit and the base, the adjustable rotary member having a first restriction hole passing through the adjustable rotary member, a through hole aligned with the insertion hole and an extensible/retractable key section, the through hole being formed at a center of the adjustable rotary member in adjacency to the first restriction hole, the key section being positioned on a circumference of the adjustable rotary member.

8. The conversion device of power tool as claimed in claim 7, wherein the base is formed with a sink opposite to the receiving space, the sink being formed on a first side of the base in communication with the perforation and the receiving space.

9. The conversion device of power tool as claimed in claim 8, wherein the base is further has multiple tooth-shaped dents formed along a circumferential wall of the sink for engaging with the corresponding key section.

10. The conversion device of power tool as claimed in claim 9, wherein the cap member is formed with a recessed section, the recessed section being formed on one side of the cap member, which side faces the transmission unit.

11. The conversion device of power tool as claimed in claim 10, wherein the second extension section is attachable and connected to a power tool.

12. The conversion device of power tool as claimed in claim 11, wherein the cap member has multiple hook sections annularly arranged along the circumference of the cap member.

13. The conversion device of power tool as claimed in claim 12, wherein the power tool is fitted with a corresponding fitting member, the fitting member having a ring body, multiple movable sections and multiple latch sections, the movable sections being arranged at one end of the ring body at intervals, free ends of the movable sections being movably connected with the corresponding latch sections, the latch sections being fixedly fitted on the corresponding hook sections.

14. The conversion device of power tool as claimed in claim 1, wherein the cutting unit is selected from a group of reciprocal linear motion tools, consisting of a saw blade, a chisel, a hammer, a blade and a file, the cutting unit being linearly back and forth movable for cutting a work piece.

15. The conversion device of power tool as claimed in claim 4, wherein the first and second engagement sections are in the form of a wave shaped plate.

16. The conversion device of power tool as claimed in claim 8, wherein the connection unit is further formed with a second restriction hole passing through the connection unit between the insertion hole and the circumference of the connection unit, the second restriction hole communicating with the first restriction hole, an insertion pin being inserted through the second and first restriction holes.
